(19) United States
(12) Patent Application Publication
(10) Pub. No.: US 2012/0256408 A1
(43) Pub. Date: Oct. 11, 2012

(54) Creative Illustration Book

(76) Inventor: Tara Anne Malia, Manasquan, NJ (US)

(21) Appl. No.: 13/530,217

(22) Filed: Jun. 22, 2012

Related U.S. Application Data
(63) Continuation-in-part of application No. 12/802,785, filed on Jun. 14, 2010.

(51) Int. Cl. B42D 15/00

(52) U.S. Cl. 283/63.1

(57) ABSTRACT

A creative illustration book is provided that has a story page that has pre-printed text of a written story, and an illustration page that does not have any of the pre-printed text of the written story. The illustration drawn by the user is located on the illustration page. The illustration may be removable from the illustration page.

### CROSS REFERENCE TO RELATED APPLICATION

This application is a continuation-in-part and claims the benefit of U.S. application Ser. No. 12/802,785 filed on Jun. 14, 2010 and entitled, “Creative Illustration Book.” U.S. application Ser. No. 12/802,785 is incorporated by reference herein in its entirety for all purposes.

### FIELD OF THE INVENTION

The present invention relates generally to children's books. More particularly, the present application involves a creative illustration book that allows a child to illustrate a children's book while still maintaining the written story of the book in an original, non-modified state. Further, the creative illustration book allows the child's illustrations to be displayed or kept separately from the original, non-modified story portions of the book if desired.

### BACKGROUND

It is commonly accepted that exposure to books provides children with a wide range of benefits that allows them to further excel in other areas. For example, reading enhances language and speech development and fosters a clearer understanding of grammar and vocabulary. Children that read may also strengthen their writing skills, memory, focus, and learning abilities. Aside from the aforementioned improvements, reading may also provide entertainment and enhance the creativity of a child. As such, reading is a significant aspect of a child's education and development.

Children's books have been designed to foster the free expression and imagination of the child reader. One such book is a picture book that includes a series of pictures that are partially completed. The leaves of the book are coated with a transparent synthetic plastic layer that can be written on by the child with the use of a pen having water-soluble ink. The child may flip through the picture book and complete the partially completed illustrations, or may write or draw on the book as desired. The ink is erasable so that the child or parent can then remove the markings to return the picture book to its original state. The leaves of the picture book are thus non-removable, and a written story is not provided. Also, the ink is erasable and hence temporary, and the markings are made so as to complete existing illustrations.

Another children's book that has been developed in order to foster the creative writing abilities of the child includes a series of pages that feature different illustrations. Each illustration builds upon a particular theme, and the child will write a story corresponding to the sequence of images displayed in subsequent illustrations. Once completed, the illustrations and written story are removed from the book and saved for later evaluation. The book contains an additional or several additional identical sequences of images. In the future, the child can go back and write another story corresponding to the sequence of images and then remove this second set of pages from the book. The stories generated by the child can then be compared in order to track the child's writing development. Although capable of fostering writing abilities of the child, such a system does not allow for the creation of illustrations, requires the read story to be removed from the book, does not leave the read story within the book, and does not include a written story. Although capable of advancing creative writing skills and drawing skills, current children's books fail to foster the creation of illustrations based upon a permanent written story. As such, there remains room for variation and improvement within the art.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a perspective view of an introduction page of a creative illustration book in accordance with one exemplary embodiment.

FIG. 2 is a perspective view of a pre-printed illustration page and a story page of the creative illustration book of FIG. 1.

FIG. 3 is a perspective view of an illustration page of the creative illustration book of FIG. 1.

FIG. 4 is a perspective view of the back of the illustration page shown in FIG. 3.

FIG. 5 is a front view of a blank illustration page in accordance with one exemplary embodiment.

FIG. 6 is a front view of an illustration page in accordance with another exemplary embodiment that has pre-printed text and a pre-printed illustration thereon.

FIG. 7 is a front view of an illustration page in accordance with one exemplary embodiment that includes a pre-printed boarder.

FIG. 8 is a front view of a book that is displayed by an electronic device in accordance with another exemplary embodiment.

FIG. 9 is a front view of an illustration page of a book that is displayed on an electronic device.

FIG. 10 is a schematic view of an electronic device that may be used to display a book in accordance with another exemplary embodiment.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a creative illustration book 10 that may be used for educational and recreational purposes. The creative illustration book 10 may function to stimulate reading comprehension and facilitate creative drawing in the child. The creative illustration book 10 can include one or more story pages 12 that include pre-printed text of a written story 22. One or more illustration pages 14 can also be included in the creative illustration book 10. The child may draw illustrations 24 onto the illustration pages 14 that visually represent the story being told in the rest of the book 10. Alternatively, the child may draw illustrations 24 onto the illustration pages 14 that function to complete the story or that have nothing at all to do with the story. The illustrations pages 14 with the drawn illustrations 24 can be removed from the book 10 and placed at any desired location. For example, the removed illustration pages 14 with illustrations 24 can be put on the refrigerator, posted on a wall, or placed into a frame or album. The story pages 12 are not removable from the creative illustration book 10 so that the child can re-read the pre-printed text of the written story 22 at a later date and so that the written story remains complete. In some embodiments the book 10 may be used by a therapist or a child in a hospital such that the book 10 can be used for therapeutic purposes, or while the child is being treated for an injury or disease, or to aid the child who is experiencing a traumatic life event.

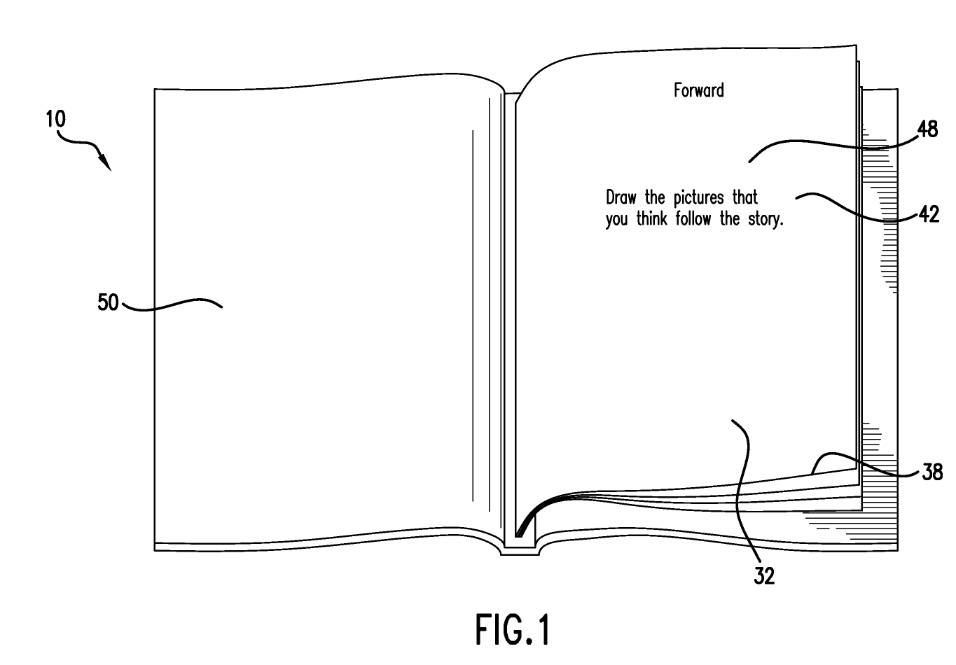

FIG. 1 shows a creative illustration book 10 in accordance with one exemplary embodiment of the present invention. The book 10 is open so that the inside of the front cover 50 of the book 10 can be seen in addition to an instruction page 42 located on a leaf 38 of the book 10. The cover 50 can be either a hard back cover or a soft back cover in accordance with various embodiments. The instruction page 42 can function as a forward of the book 10 and may provide instructions written in pre-printed text 48 to the child, or guardian of the child, as to the proper use of the book 10 as will be explained below. The leaf 38 can be permanently attached to the cover 50 of the book so that it is non-removable. It is to be understood, however, that the instruction page 42 need not be present in accordance with other exemplary embodiments of the creative illustration book 10. Although disclosed as being on the first leaf 38 of the book 10, the instructions 48 can be on any portion of the book 10. For example, the instructions 48 may be on the outside of the back of the cover 50 of the book 10 in some embodiments.

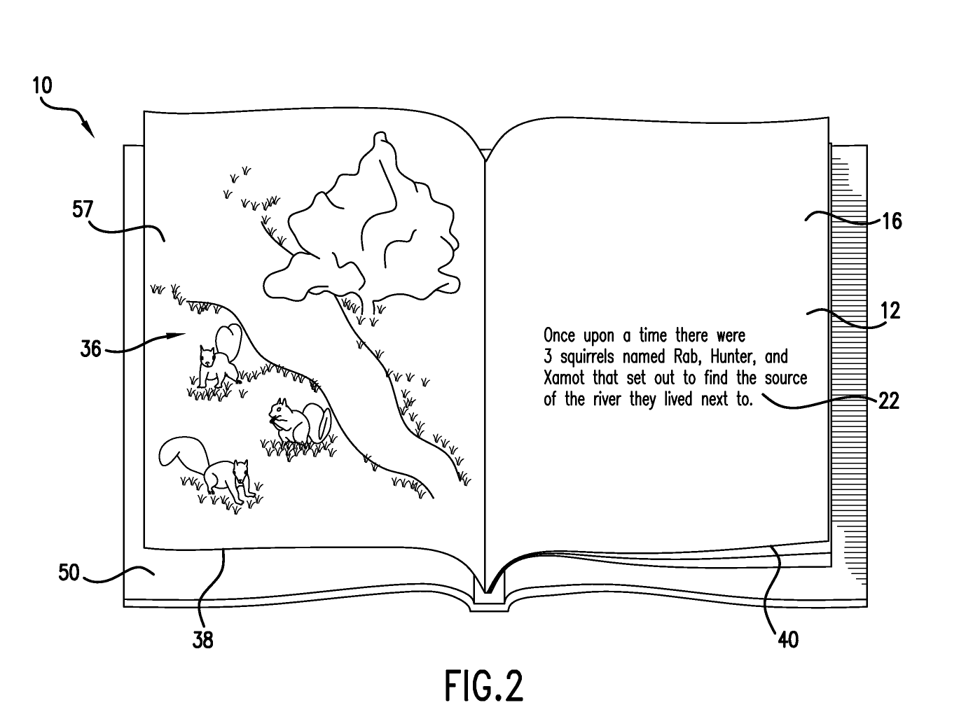

Turning of the instruction page 42 reveals a graphical page 57 that is on the back side of the leaf 38 that contains the instruction page 42. The graphical page 57 is shown in FIG. 2. The graphical page 57 may include a pre-printed illustration 36 that relates to a written story provided in the rest of the book 10. As used herein, the term “pre-printed” refers to text or illustrations that are made by a publisher or producer of the book 10 before being purchased by the child or the child's guardian. The pre-printed text or illustrations are not drawn or created by the child or the child's guardian but rather by a producer of the book 10. Although shown as having a graphical page 57, it is to be understood that other arrangements of the creative illustration book 10 are possible in which no pre-printed illustrations 36 are provided. Further, although shown as being on the opposite side of instruction page 42 and before the start of the written story, the graphical page 57 may be located at other points in the book 10. Also, any number of graphical pages 57 may be utilized in other exemplary embodiments. For example, from 2-5, from 6-10, up to 15, or up to 200 graphical pages 57 can be employed in other arrangements of the creative illustration book 10.

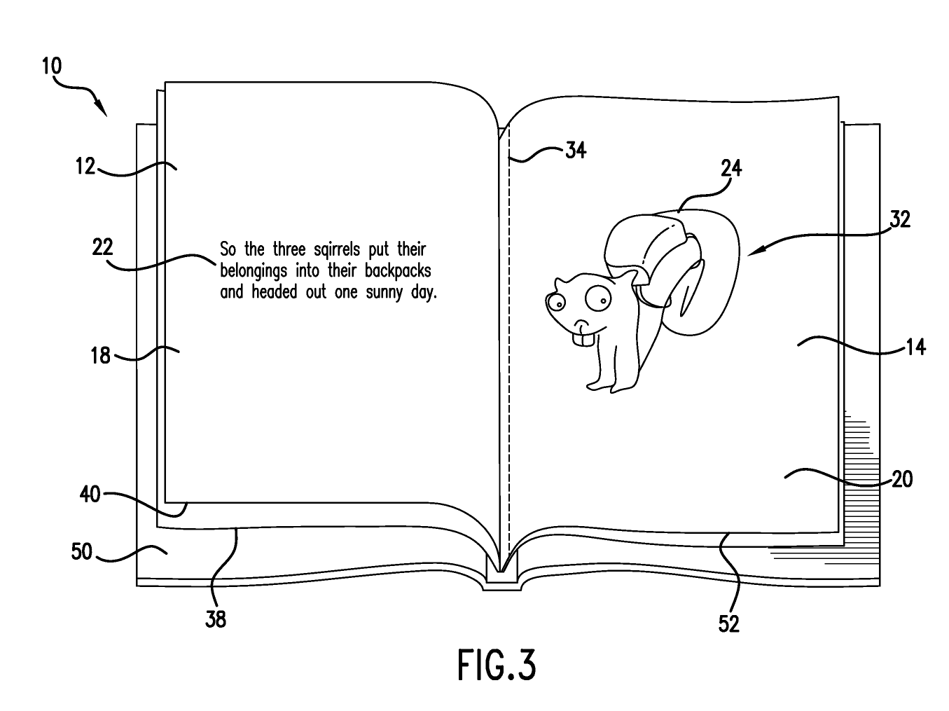

The second leaf 40 of the book 10 includes a first page 16 that is a story page 12. Pre-printed text of the written story 22 is located on the story page 12. The written story 22 may be a children's story and may or may not relate to the pre-printed illustrations 36 shown in other portions of the book 10. The child or the child's guardian may read the story on the story page 12 to the child and turn the leaf 40 once completed to reveal the book 10 as shown in FIG. 3. Here, a second page 18 is located on the back of the first page 16 and is likewise a story page 12 that includes pre-printed text of the written story 22 that carries over from the previous page 16. Leaf 40 is permanently attached to the cover 50 of the book 10 so that the leaf 40 and the pre-printed text of the written story 22 on pages 16 and 18 cannot be removed from the cover 50.

A third leaf 52 may be included in the book 10 and can include a third page 20 that is an illustration page 14. The illustration page 14 may be arranged so that no portion of the pre-printed text of the written story 22 is present on the illustration page 14. The illustration page 14 is provided in order for the child to create his or her own illustration 24 thereon. The illustration 24 is a graphic or picture drawn by the child. In certain exemplary embodiments, the illustration 24 does not contain text written or drawn by the child. The child can create the illustration 24 by way of permanent ink in certain embodiments. The illustration 24 may be created by the use of pens, crayons, or markers. In other embodiments, the child may create an illustration 24 through an erasable instrument such as a pencil or colored pencils so that the entire illustration 24 or portions thereof may be erased. The child can decide an appropriate illustration 24 to create based upon his or her imagination or impression regarding previous comprehension of the written story 22. The child may decide to create an illustration 24 based upon an image thought of by the child upon hearing the written story 22 that relates to the characters or story or to how the story will develop. The child may alternatively decide to create an illustration 24 that is not related to the written story 22.

The third leaf 52 that includes the illustration page 14 may be provided with perforations 34 that allow the third leaf 52, and hence illustration page 14 to be removed from the cover 50 so that they can be in effect removed from the book 10. The perforations 34 are a series of apertures or weakened points in the paper third leaf 52 that allow the portion of the third leaf 52 along the perforations 34 to be easily removed or torn. The child can then place the illustration page 14 with the drawn illustration 24 at a desired location such as on a refrigerator, wall or in a frame. Alternatively, the child may first remove the illustration page 14 by way of the perforations 34 and then subsequently create the illustration 24 on the illustration page 14 while the illustration page 14 is detached from the cover 50. The perforations 34 render the illustration page 14 removably attachable to the cover 50 and hence book 10. Other arrangements of causing the illustration page 14 to be removably attachable to the book 10/cover 50 are also possible. For example, clips or hook and loop type fasteners can be used to allow the illustration page 14 to be attached to the book 10/cover 50 and then be removed from the book 10/cover 50. The mechanism for rendering the illustration page 14 removably attachable may be non-reversible so that once detached, the illustration page 14 cannot be subsequently reattached to the book 10/cover 50. One such example of this is the provision of the perforations 34 onto the third leaf 52 as discussed. In other exemplary embodiments, the illustration page 14 can be reattached to the book 10/cover 50 so that the illustration page 14 can be repeatedly removed and then attached.

Removal and subsequent placement of the illustration page 14 with the drawn illustration 24 at a location remote from the book 10 provides visual stimulation to the child and acts as a reminder of the written story 22 of the book 10. The child may then be encouraged to reread the written story 22 or to reuse the book 10 should other illustration pages 14 still remain therein that do not have illustrations 24 drawn thereon. Further, the written illustration 24 when placed at a different location can serve as a reminder to the guardian of the child of his or her time spent reading with the child.

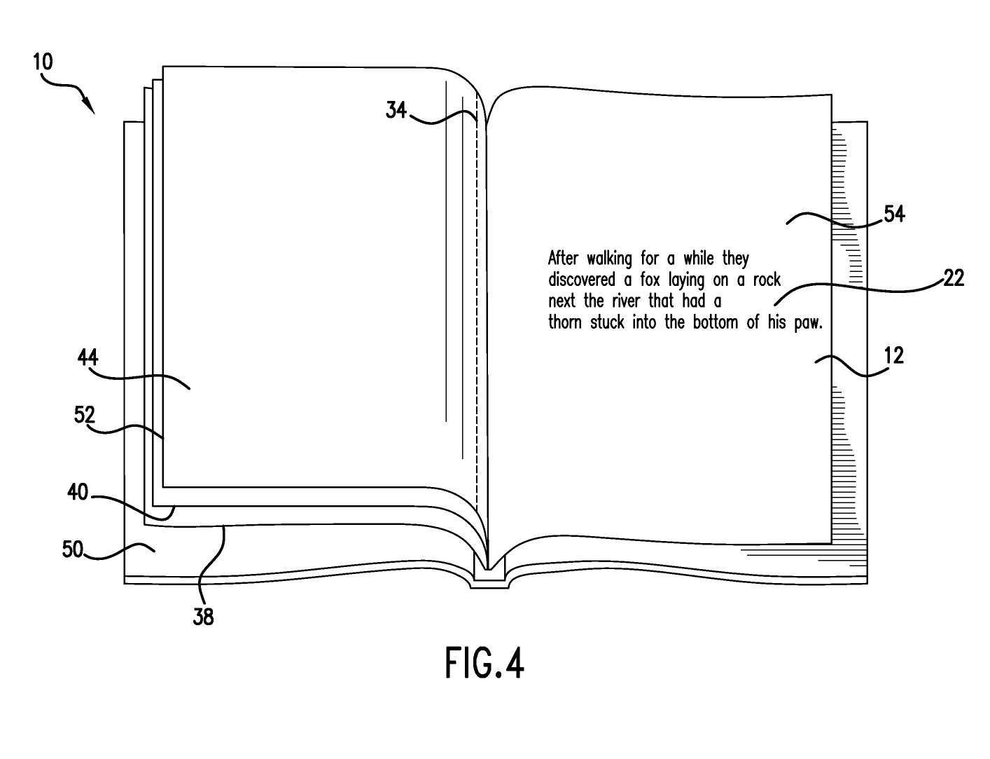

The page on the back side of the illustration page 14 is shown in FIG. 4 and is a blank fourth page 44. The fourth page 44 may be blank because the other side of the leaf 52 is in fact intended to be drawn on by the child and hence subsequently displayed. However, it is to be understood that the fourth page 44 need not be a blank page in other arrangements of the creative illustration book 10. For example, pre-printed text 48 for instructions regarding the usage of the book 10 may be on the opposite side of the leaf 52 from the illustration 24. Additionally or alternatively, a pre-printed illustration 36 could be located on the fourth page 44 in other arrangements.

The text of the written story 22 from the second page 18 may continue onto the story page 12 located on the leaf 54. Leaf 54 may again be permanently attached to the cover 50 so that it is non-removably attached to the cover 50/book 10. Non-removable attachment of the leaf 54, in addition to others previously described as non-removably attached, may be effected through the use of conventional book binding of the leaf 54 to the cover 50. In effect, the leaf 54, in addition to others described as non-removably attached, are not provided with perforations 34 or other mechanisms that render them removable. The entire text of the written story 22 can be contained on story pages 12 that are permanently attached to the book 10 and thus are not removable. As such, the creative illustration book 10 can have written illustrations 24 by the child removed but may maintain the entire written story 22 within so as to be located in a single location. The written story 22 may then be saved for subsequent rereading in the future as desired.

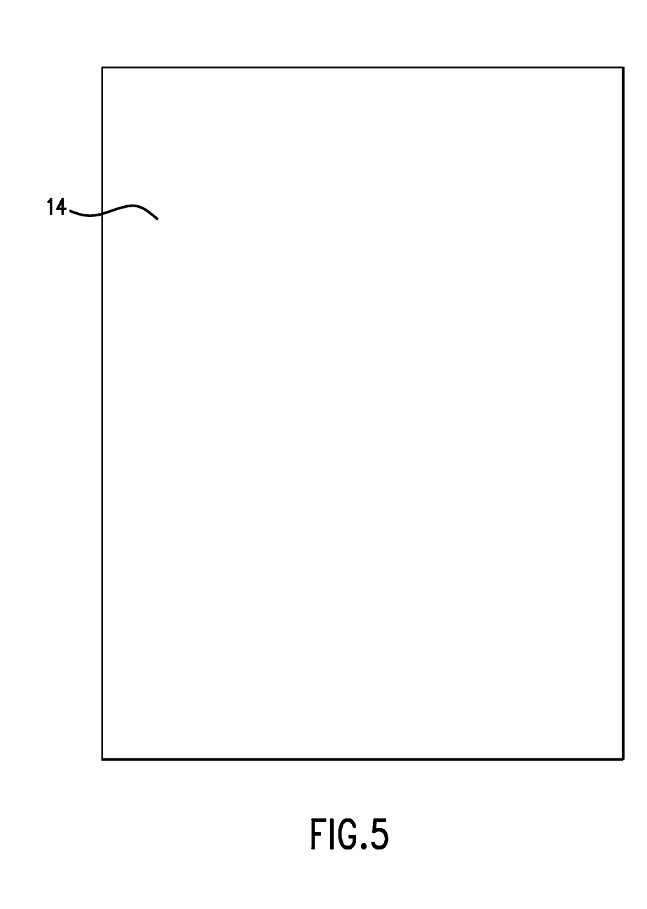

The illustration page 14 can be arranged in a variety of manners. FIG. 5 shows one exemplary embodiment in which the illustration page 14 is blank. The child may create an illustration 24 at any location on the blank illustration page 14. Although not shown, the leaf having the illustration page 14 can be perforated through the use of perforations 34 as previously discussed to cause the illustration page 14 to be removably attached to the book 10.

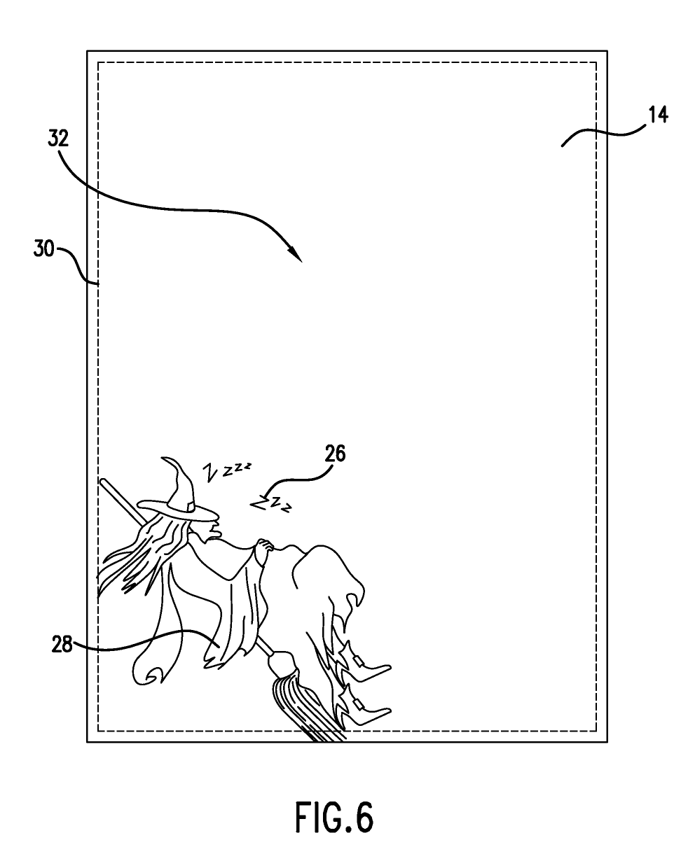

FIG. 6 illustrates another exemplary embodiment of the illustration page 14. The illustration page 14 includes a pre-printed illustration 28 that may or may not relate to characters or issues associated with the written story 22. The pre-printed illustration 28 may be located in any portion of the illustration page 14. As shown, the pre-printed illustration 28 is located in a corner of the illustration page 14. In other arrangements, the pre-printed illustration 28 is located in the side, at the top, or at the bottom of the illustration page 14. The pre-printed illustration 28 may be small or large and can be located at any spot on the illustration page 14 in other arrangements. The pre-printed illustration 28 may be suggestive of an illustration 24 that is to be drawn by the child so that the child will have a hint as to what illustration 24 to make. However, the instruction page 42 can state that the child is to draw an illustration 24 of his or her own choosing regardless of the hint provided by the pre-printed illustration 28. The illustration page 14 can also include pre-printed text 26 thereon that relates to either the pre-printed illustration 28 or to the written story 22 or otherwise. A pre-printed boarder 30 can also be included and may extend around an area 32 of the illustration page 14 that is the area designated for the child to draw the illustration 24 thereon. As with other described illustration pages 14, the illustration page 14 in FIG. 6 can be provided with perforations 34 so as to be removably attached to the book 10.

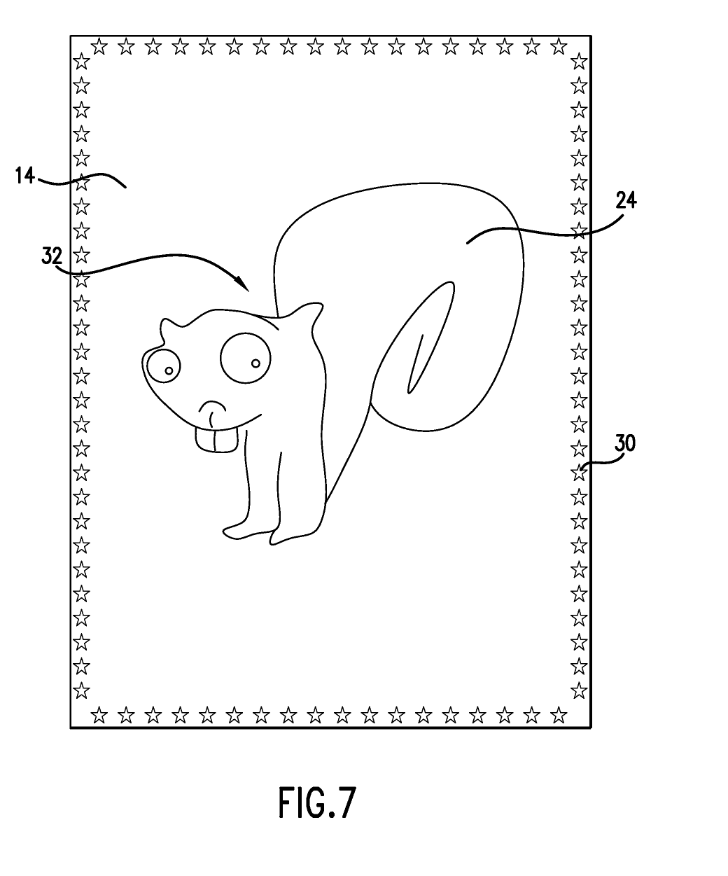

FIG. 7 is an alternative exemplary embodiment of an illustration page 14 in which pre-printed text 26 is not present. However, the illustration page 14 is provided with a pre-printed boarder 30 of stars that create an area 32 into which the child can draw the illustration 24. The pre-printed boarder 30 need not be stars in other arrangements. For example, the pre-printed boarder 30 may be circles, dashes, letters, numbers, animals, half-moons, or apples in accordance with other exemplary embodiments.

Although described herein as having a first page 16, second page 18, third page 20 and fourth page 44, it is to be understood that any number of pages may be present in the book 10 and the aforementioned pages need not be in sequential order with one another. For example, the third page 20 as discussed may appear in the book 10 in sequence before the first or second pages 16 and 18 in certain arrangements. Further, although only a single illustration page 14 is shown in the enclosed figures, it is to be understood that any number of illustration pages 14 may be present in accordance with other exemplary embodiments. For example, from 2-5, from 6-10, or up to 30 illustration pages 14 may be present in accordance with other exemplary embodiments of the creative illustration book 10. Likewise, any number of story pages 12 or instruction pages 42 can be employed. From 2-5, from 6-10, or up to 30 story pages 12 and/or instruction pages 42 can be present in other configurations of the book 10.

The instruction page 42 may inform the user that the book 10 contains one or more illustration pages 14 that are designed for a child to draw an illustration 24 thereon. The instruction page 42 may inform the user that the child should draw the illustration 24 in permanent ink because the illustration page 42 with included illustration 24 will be subsequently removed from the book 10 and displayed or saved. The instruction page 42 can instruct the user to read the text of the written story 22 to the child or have the child himself or herself read the text of the written story 22. Upon encountering an illustration page 14, the pre-printed text 48 of the instruction page 42 may instruct the user to stop reading the written story 22 and draw an illustration 24 onto the encountered illustration page 14. The instruction page 42 can then instruct the user to remove the illustration page 14 from the cover 50 through the tearing of the leaf having the illustration page 42 by way of perforations 34, or other removably attachable mechanism, and subsequent display or storage of the illustration page 14.

The instruction page 42 can inform the user that the child should create an illustration 24 based upon the written story 22, what will happen in the written story 22, or based upon some other item the child is thinking of upon reading through the written story 22. In some embodiments, the instruction page 42 may instruct the user to have the child create an illustration 24 based completely upon what the child is thinking at the time and not based upon the written story 22 or the particular pre-printed illustration 28 on the illustration page 14. The instruction page 42 may inform the user to continue on through the book 10 reading the written story 22 and creating illustrations 24 as encountered until all of the illustration pages 14 have illustrations 24 drawn thereon. The instruction page 42 may also indicate to the user that once all of the illustration pages 14 are removed, the resulting story pages 12 are permanently attached to the cover 50 and thus will remain together in the book 10 so that the entire written story 22 could be reread and so that none of the written story 22 is located on any of the leaves that also contain the illustration pages 14. In an alternative exemplary embodiment, the instruction page 42 may instruct the user to create the illustrations 24 but not to remove any of the illustrations 24 from the book 10. In these instances, the illustration page or pages 14 are maintained within the book 10 and are not removed therefrom so that the written story 22 and the created illustrations 24 are kept within the book 10 for later review.

The various leaves 52, 54 of the book 10 can be constructed out of paper. Certain ones of the leaves 52 and/or 54 may be permanently attached to the cover 50 of the book 10. The printed matter, such as the text 22, can be present on both the front and back side of a particular leaf 52. The leaves 52 and/or 54 can be attached so that their attachment point on their edges is longer than the unattached edges that are contiguous with the attached edge.

The instructions on the instruction page 42 in some embodiments do not tell the user what to draw. Instead, the instructions on the instruction page 42 encourage the user to draw whatever they want on the illustration page 42. Although this could be something related to the story that is being told on the story pages 12, it could also be anything else that enters the user's mind during reading of the book 10. As such, the book 10 encourages the user to think independently and creatively instead of functioning as a “paint by numbers” or rigid instructional book. The illustrations 24 in some arrangements are not produced by filling in sections of a pre-printed illustration 28, such as the case with a coloring book, but are instead drawn by the user without the benefit of outlines. In other arrangements, pre-printed illustrations 28 are used by the user to construct the illustration 24. The leaves 52, 54 onto which illustration page 14 is included are not die cut in certain embodiments. In this regard, once removed from the book 10 via the perforations 34 or other removal mechanism the removed illustration page 14 is a flat page with no pop-up parts or other removable parts from the removed illustration page 14. As such, in certain exemplary embodiments the removed illustration page 14 is not a pop-up image but presents the illustration 24 on a flat surface that is of the same elevation as the rest of the removed surface onto which the illustration 24 is disposed.

In accordance with another exemplary embodiment, the creative illustration book 10 can be arranged so that all of the pages and leaves are non-removably attached to the cover 50 of the book 10. In this regard, the illustration page or pages 14 cannot be removed from the book 10. FIG. 5 shows an illustration page 14 without any perforations, and the illustration page 14 may be provided as any other page in the book 10 that is non-removably attached. The other pages such as the story page 12, instruction page 42, graphical page 57 and any other page in the book 10 are as well all permanently attached to the book 10 and cannot be detached from the cover 50. In yet other arrangements, the illustration page 14 is permanently attached while one or more of the other pages such as the story page 12 and instruction page 42 are removably attached to the book 10. With this arrangement the illustration page or pages 14 can remain in the book 10 and attached to the cover 50 so that the book 10 results in simply a bound set of one or more illustrations 24 by the user within the book 10. As such, various exemplary embodiments exist in which any combination of the pages 12, 14, 57 and/or 42 are removable and are non-removable from the book 10. In some embodiments there are no perforations present in any of the pages of the book 10. In this instance, the leaves are permanently attached to the cover 50.

The creative illustration book 10 can be constructed so that the illustration page 14 is an erasable page. In one regard, the user may use an erasable utensil, such as a pencil, to create the illustration 24. The user can erase the illustration 24 and redraw the illustration 24 as desired. The erasing can be made before or after the illustration page 14 is removed from the book 10 if the illustration page 14 is of a removable type. In other embodiments, the illustration page 14 can include a sheet of paper and/or plastic sheeting onto which the user can draw the illustration 24. The user may use a marker or other utensil to draw the illustration 24 and then subsequently erase the illustration 24 that was created. A cloth or wet towel can be used to wipe the ink or other substance making up the illustration 24 from the illustration page 14. This functionality allows for the book 10 to be reused multiple times while still allowing different illustrations 24 to be created by the user. The entire illustration page 14 can be a piece of paper and/or plastic sheeting that can be permanently attached to the cover 50 or may be removably attached to the cover 50 via the various mechanisms discussed. As such, the entire leaf 52 that includes the illustration page 14 may be made of paper and/or plastic sheeting that is erasable.

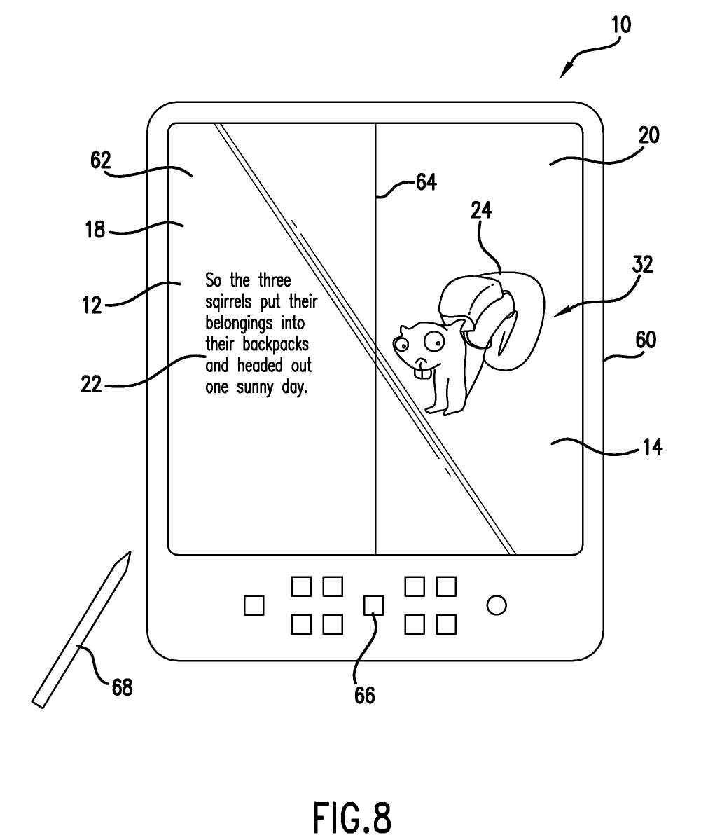

The creative illustration book 10 can be provided in electronic format in accordance with certain exemplary embodiments. With reference to FIG. 8, the book 10 is provided to the user in an electronic device 60 that can be, for instance, a digital book reading device, a cell phone, a PDA, a computer, tablet, or any other type of electronic device capable of displaying graphical and textual content. The content that is displayed to the user may be downloaded to the electronic device 60 into a permanent memory location 74 of the device 60, or may be in temporary memory 72 of the electronic device 60 which reads the content from a remote location such as a server 80 via the internet. The book 10 can be stored in electronic format and can be downloaded by the electronic device 60 for display of the various pages onto the display screen 62. With such an arrangement, leaves of the book 20 are not present as would be the case when the book 10 is arranged with paper leaves 52. The book 10 may be an electronic tablet application or a computer application in accordance with certain exemplary embodiments.

The electronic device 60 may include a central processing unit (CPU) 70, input keys 66 such as a keyboard or a mouse to obtain input from the user, permanent non-volatile memory 74, temporary memory 72, and a modem 78 or other communication device capable of placing the electronic device 60 into communication with a router, server, or other component of a network.

In electronic format, the book 10 is viewable upon a screen 62 of the electronic device 60 that displays one or more pages 16, 18, 20. As shown in FIG. 8, pages 18 and 20 are displayed to the user simultaneously on the screen 62. Page 18 is separated from page 20 via a split line 64 that extends in the vertical direction so that a split screen view is presented to the user of the book 10. Page 18 is a story page 12 of the book 10 and includes text 22 of the written story as previously discussed. Page 20 is an illustration page 14 of the book 10 and may be initially provided as a blank page. Upon viewing the pages 18 and 20 on the screen 62, the user may first read the text 22 of the written story and then draw an illustration 24 onto the illustration page 14 as previously discussed. The user can employ an electronic pen 68 or other input device such as a mouse or keys to create the electronic illustration 24. The book 10 may be arranged so that the illustration 24 cannot be added to pages of the book other than the illustration page 14. In this manner, the program displaying the pages 18 and 20 will allow an electronic illustration 24 to be created onto page 20 but not onto page 18.

The illustration pages 24 can be interspaced throughout the book 10 so that certain ones of the story pages 12, graphical pages 57, and/or instruction pages 42 are between successive ones of the illustration pages 24. In other arrangements, the illustration pages 24 are at the end of the book 10 so that the story pages 12, graphical pages 57 and/or instruction pages 42 are in front of the illustration pages 24 in sequence of the pages of the book 10. The illustration pages 24 can be blank pages where applications can be used to draw the illustrations 24.

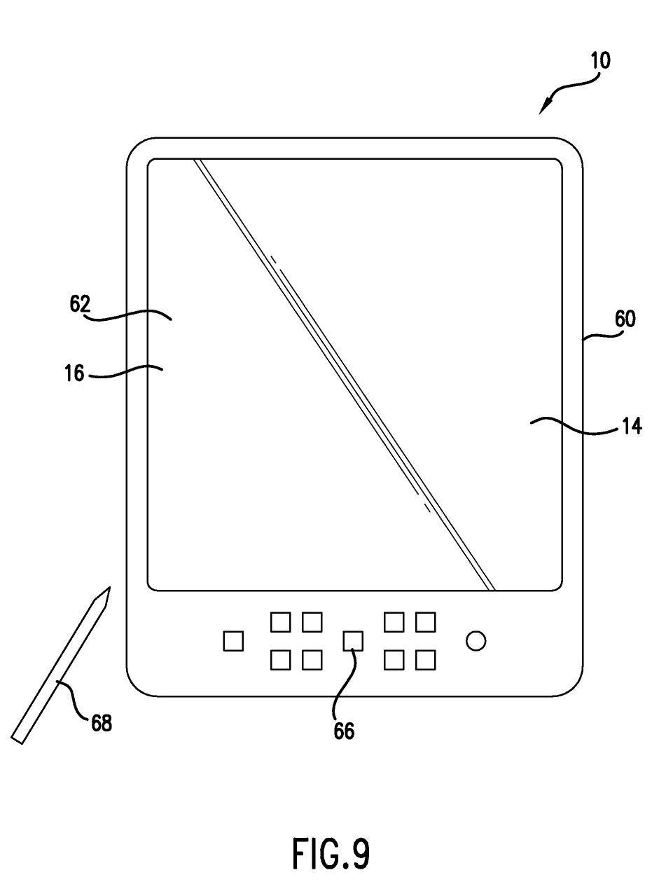

FIG. 9 shows the creative illustration book 10 in electronic format such that it is incorporated into an electronic device 60. The illustration page 14 takes up the entire screen 62. This page 16 may be part of the book 10 shown and described with reference to FIG. 8 or may be part of a different exemplary embodiment of the book 10. A split line 64 is not present so that two or more pages 18 and 20 are not displayed on the screen 62 but instead a single page 62 is displayed. The user may create an illustration 24 onto the illustration page 14 as discussed by way of the input devices 66 such as keys or a mouse, and/or by way of the electronic pen 68. The various pages 12, 57, 42, and/or 24 can be displayed one at a time on the screen 62 or multiple ones of the pages 12, 57, 42 and/or 24 can be displayed at the same time on the screen 62 to the user.

The electronically created illustrations 24 can remain a part of the book 10 so that the next time the user reads the book 10, the created illustrations 24 are presented to the user on the various illustration pages 14. In other embodiments, the created illustrations 24 and/or the created illustrations and any other pre-printed texts, illustration, and/or boarder 26, 28, 30 on the illustration pages 14 can be downloaded to a file, saved in memory, or exported to another program. The illustrations 24 may be erasable by the user such that they are electronically erased and so that a new illustration 24 can be created either at the present time, or at the next time the user reads the book 10. In order to erase the electronically produced illustration 24, the user may actuate one of the input keys 66. The created illustrations 24 can be saved to a file either on the electronic device 60 or onto another storage medium for future reference or may simply be deleted without being saved.

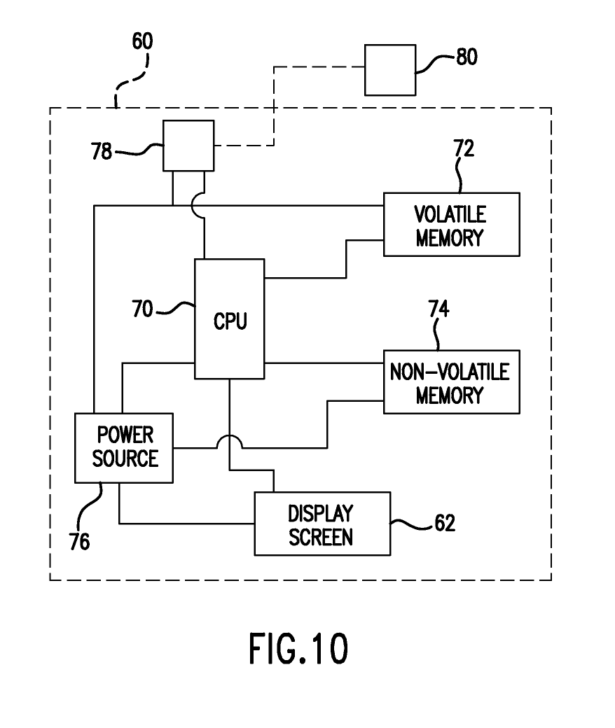

FIG. 10 shows one exemplary embodiment of the electronic device 60 that includes a central processing unit (CPU) 70 in communication with a screen 62 that displays the various pages 12, 42, 57, 14 of the book 10. The CPU 70 is in communication with volatile memory 72 and non-volatile memory 74. Illustrations 24 can be sorted in the non-volatile memory 74 for future access and viewing by the user. The electronic device 60 also includes a power source 76 for powering the CPU 70, volatile memory 72, non-volatile memory 74, and display screen 62 along with a modem 78. The modem 78 may be used to allow the electronic device 60 to communicate with other devices such as a server 80. In this manner, the book 10 can be retrieved or downloaded from the server 80 and the illustrations 24 may be sent to the server 80 via the modem 78 that is in communication with the CPU 70.

The book 10 may be a story book in that the story that is told conveys a message to the reader. The book 10 is not a coloring book in some embodiments in that there are no illustrations present for a user to color. In these embodiments color is not applied to any illustrations or other portions of the book 10, although the user may use a colored writing instrument to create an illustration.

In accordance with another exemplary embodiment, the book 10 can be provided so as to be used by users that are visually impaired, for example those that are blind. In these embodiments, the text of the written story 22 is made of brail so that the user can read the written story even though he or she has trouble seeing. The illustrations 24 can also be created so that they can be interpreted by a user that is blind or visually impaired. The illustration page 14 can be made of special paper, special markers may be used, and embossments can be generated so the user can create an illustration 24 on the illustration page 14 that can be felt by or otherwise discernable by the blind or visually impaired user. The illustrations 24 can be raised or lowered with respect to a leaf 52 onto which the illustration 24 is located so that it can be discerned by the user. If the book 10 is in electronic format, the text of the written story 22 may be read to the user via a text to voice converter and the illustration 24 may be created by the user through any of the means previously discussed. The illustration 24 may be made on a physical, paper page separate from the electronic book 10, or may be input into the device 60 that contains the electronic book 10. Audio statement from the device 60 can describe to the use what he or she is creating in on the illustration page 14 so that the user will know what the illustration 24 looks like.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A creative illustration book, comprising:
a first page that has pre-printed text of a written story, wherein the first page is non-removably attached to a book;
a second page that has the pre-printed text of the written story, wherein the second page is non-removably attached to the book; and
a third page onto which an illustration drawn by a user of the book is located, wherein the third page is devoid of any of the pre-printed text of the written story, wherein the third page is non-removably attached to the book.

2. The creative illustration book as set forth in claim 1, wherein the third page has pre-printed text thereon that is not the pre-printed text of the written story, wherein the third page is made of paper.

3. The creative illustration book as set forth in claim 1, wherein the third page has a pre-printed illustration thereon that relates to the written story.

4. The creative illustration book as set forth in claim 3, wherein the pre-printed illustration on the third page is located in a lower corner of the third page.

5. The creative illustration book as set forth in claim 1, wherein the third page has a pre-printed boarder thereon that completely surrounds an area of the third page designated for having the illustration to be drawn by the user.

6. The creative illustration book as set forth in claim 1, wherein the illustration drawn by the user is in permanent ink.

7. The creative illustration book as set forth in claim 1, wherein the first page, the second page, and the third page are not successive pages with one another and are not located at the front of the book such that they are not the first, second and third pages in sequence in the book.

8. The creative illustration book as set forth in claim 1, wherein a leaf of the book that has the third page is made of plastic such that the illustration placed onto the third page is subsequently removed by the user from the third page.

9. The creative illustration book as set forth in claim 1, further comprising an instruction page that has pre-printed text thereon that informs a reader of the purpose and use of the third page.

10. The creative illustration book as set forth in claim 1, wherein the illustration is erasable such that user subsequently erases the illustration after drawing the illustration.

11. The creative illustration book as set forth in claim 1, wherein the illustration is drawn by a user that is visually impaired and wherein the illustration can be felt by the user to determine its shape.

12. A creative illustration book, comprising:
a story page that has text of a written story, wherein the story page is displayed on a display of an electronic device; and
an illustration page that does not have any of the text of the written story, wherein an illustration drawn by the user is on the illustration page, wherein the illustration page and the illustration on the illustration page is displayed on the display of the electronic device.

13. The creative illustration book as set forth in claim 12, wherein the illustration on the illustration page is removable from the book such that after the illustration is placed onto the illustration page the illustration is removed and no longer present on the illustration page.

14. The creative illustration book as set forth in claim 13, wherein the removed illustration is saved into a file for subsequent retrieval.

15. The creative illustration book as set forth in claim 13, wherein the removed illustration is deleted and no longer accessible by the user.

16. The creative illustration book as set forth in claim 12, wherein the display has a split line, wherein the story page and the illustration page are simultaneously displayed on the display and are separated by the split line.

17. The creative illustration book as set forth in claim 12, wherein the electronic device is selected from the group consisting of a desktop computer, a laptop, a digital book reading device, a tablet, a cell phone, and a personal digital assistant (PDA);
wherein the illustration is drawn by the user through the use of a device selected from the group consisting of an electronic pen, input keys, and a mouse.

18. A creative illustration book, comprising:
a story page that has pre-printed text of a written story; and
an illustration page that does not have any of the pre-printed text of the written story, wherein an illustration drawn by the user is located on the illustration page, wherein the illustration is removable from the illustration page.

19. The creative illustration book as set forth in claim 18, wherein the illustration page is a leaf of the book that is made of plastic such that the illustration placed onto the illustration page is subsequently removed by the user from the illustration page by wiping the illustration off of the plastic.

20. The creative illustration book as set forth in claim 18, wherein the story page is displayed on a screen of an electronic device, wherein the illustration page and the illustration are displayed on the screen of the electronic device, wherein the illustration is removable from the illustration page and is saved by the user for subsequent viewing.
